(19) United States
(12) Patent Application Publication
(10) Pub. No.: US 2015/0127192 A1
(43) Pub. Date: May 7, 2015

(54) WIRELESS VEHICLE CONTROL SYSTEM

(71) Applicant: Hitachi, Ltd, Tokyo (JP)

(72) Inventors: Sujit Phatak, Farmington Hills, MI (US); Donald J. McCune, Farmington Hills, MI (US)

(73) Assignee: Hitachi, Ltd, Tokyo (JP)

(21) Appl. No.: 14/073,241

(22) Filed: Nov. 6, 2013

(51) Int. Cl. B60R 16/023

(52) U.S. Cl. CPC B60R 16/0231
USPC 701/2

(57) ABSTRACT

A vehicle control system for a vehicle having a plurality of sensors and a plurality of actuators. The control system includes a sensor-actuator-transceiver (SAT) associated with each sensor and/or actuator to read and transmit and value of the sensor or receive a target value for the actuator and generate a control signal to the actuator. A server executes simulation software for each SAT as a software in the loop simulation which determines the target position of the actuators as the function of at least one sensor. A main transceiver at the server then transmits signals to the SATs to actuate the actuators to achieve a target value.

### BACKGROUND OF THE INVENTION

I. Field of the Invention

The present invention relates to vehicle control systems and, more particularly, to a vehicle control system having a plurality of sensors and a plurality of actuators.

II. Description of the Prior Art

Vehicles, and in particular automotive vehicles, typically include dozens, if not hundreds, of sensors throughout the vehicle each of which generates an output signal representative of some condition. For example, such vehicle sensors include, for example, an engine temperature sensor, an accelerator pedal position, a door open sensor, a brake pedal position sensor, and so forth.

In addition, modem automotive vehicles also include a plurality of actuators distributed throughout the vehicle. These actuators in general control the operation of the vehicle. For example, one actuator may be used to control the throttle position of the engine, another actuator may be used to actuate the vehicle brakes, and so forth.

In the vehicle control systems, an ECU containing a programmed processor was associated with each sensor as well as with each actuator. For each ECU associated with the sensor, the ECU would receive an input signal from its associated sensor, process that sensor value, and then generate an output value to one or more actuators to control the operation of the vehicle. Similarly, the ECU associated with each actuator also contains a programmed processor which determines the target position for its associated actuator as a function of received sensor inputs. That ECU then processes those inputs to determine a new target position for its associated actuator and then generates output signals to the actuator to achieve that target value.

In order to permit communication between the various ECUs in the automotive vehicle, a wire bus, such as a CAN bus, extends throughout the automotive vehicle and interconnects the ECUs for the sensors and actuators together. The CAN bus, however, provides no processing of the signals between the ECUs but, rather, merely electrically connects the ECUs together. All processing for the sensors and actuators is performed by the ECUs associated with those sensors and those actuators.

These vehicle control systems all suffer from a number of common disadvantages. One disadvantage of the previously known vehicle control systems is that the ECUs associated with each sensor and each actuator contain fairly expensive microprocessor controller chips as well as custom application specific integrated circuits (ASICs) which, together, contribute significantly to the overall cost of the vehicle.

A still further disadvantage of these vehicle control systems is that the microprocessor contained in each ECU must be separately programmed. Furthermore, reprogramming of any particular ECU can oftentimes only be accomplished by a complete redesign of the ECU. This, of course, is expensive and increases the overall cost of the vehicle.

A still further disadvantage of the vehicle control systems is that the ECUs for the sensors and actuators are hardwired together by an electrical bus extending throughout the vehicle. As the numbers of ECUs have increased, the number and amount of wiring required by the controller area network (CAN) has increased dramatically. This is disadvantageous for at least three reasons.

First, as the amount of wiring to connect the ECUs together increases, the actual cost of the wire with its connectors to accomplish the controller area network increases. This increases the overall cost of the vehicle.

Secondly, as the amount of wiring required by the CAN to connect the ECUs together increases, the assembly cost for the vehicle to assemble all of the wiring required by the CAN also increases. This also adds to the overall cost of the vehicle.

Next, as the overall complexity of the wiring to interconnect the ECUs together increases, electrical noise and electromagnetic compatibility (EMC) also increase. Such electrical noise can interfere, for example, not only in the operation of the infotainment equipment contained within the vehicle, but, if severe, the actual operation of the vehicle.

Lastly, as the amount of wiring from the CAN network increases, the actual weight contribution of the CAN network to the overall weight of the vehicle also increases. This, in turn, disadvantageously decreases vehicle performance and increases fuel consumption.

### SUMMARY OF THE PRESENT INVENTION

The present invention provides a vehicle control system which overcomes all of the above-mentioned disadvantages of the systems.

In brief, each ECU of the vehicle control systems, whether the ECU is associated with an actuator or with a sensor or both, is replaced with a low cost sensor-actuator-transceiver (SAT) having a low cost CPU. The low cost CPU merely processes received data from the sensor and generates data to be transmitted. The entire SAT together with the CPU may be standardized, i.e. the same SAT, albeit with different programming for the CPU, may be used for different sensors and different actuators throughout the vehicle.

Each SAT has a unique identification such as a single byte. In addition, each SAT will both receive and communicate its data values wirelessly through a transmitter using any standard protocol, such as Bluetooth, IPv4, etc.

Unlike the ECUs, however, the SATs do not process the data either received or transmitted to determine optimal values. Rather, the SATs associated with sensors merely transmit data representative of that sensor value while those SATs associated with actuators merely receive data indicative of a target value for its associated actuator.

In order to implement the application layer of the embedded software for the CPU for each SAT, a high performance server is contained within the vehicle. This high performance server implements the control software for each sensor and actuator as a software-in-the-loop-simulation (SILS) executed in the server. Preferably, each SAT within the vehicle is assigned a predetermined memory partition by the server so that the simulation software executed by the server may be executed concurrently.

In order to communicate with the various SATs, the server creates a data packet containing not only the data but also the identification of the target SAT. The SAT then wirelessly transmits the data through a gateway to the server in a data packet format.

While the SILS executed in the various memory partitions by the server directly communicate with their associated SATs wirelessly, in some situations it is necessary for one SILS to communicate with a different or multiple SATs. In order to accomplish this, a SILS manager executed by the server establishes communication between the various SILS and permits the SILS to communicate with other SILS which, in turn, communicate with different SATs throughout the vehicle.

A primary advantage of the vehicle control system of the present invention is that the complex ECUs associated with each sensor and actuator in the vehicle are replaced by low cost SATs throughout the vehicle and a single high performance server to process the data and communicate with the SATs. This, in turn, lowers the overall cost of the vehicle control system.

In addition, since the server communicates with the SATs wirelessly, the wire costs, installation costs, and complexity of the hardwired CAN systems is eliminated. Likewise, EMC and electrical noise which might otherwise occur from the CAN system is also eliminated.

Furthermore, for the reprogramming of the SATs from one vehicle or vehicle year and to the next requires no modification to the SAT associated with that sensor. Rather, the only modifications that may be required will be modification in the SILS software contained in the server. Since the server software is programmed in a high level language, such as C++, software modifications in the SILS software for any one or more of the SATs may be easily and rapidly accomplished.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a diagrammatic view illustrating a wireless vehicle control system;

FIG. 2 is a block schematic view of one Sensor-Actuator-Transceiver (SAT);

FIG. 3 is a chart illustrating exemplary data packets;

FIG. 4 is a flowchart illustrating the data packet generation;

FIG. 5 is a diagrammatic block view of a server;

FIG. 6 is a flowchart illustrating the sensor input processing;

FIG. 7 is a flowchart illustrating the actuator output generation;

FIG. 8 is a block diagrammatic view illustrating the SAT-SILS interface;

FIG. 9 is a flowchart illustrating the server startup;

FIG. 10 is a flowchart illustrating the operation of the SILS manager;

FIG. 11 is a flowchart illustrating the server input/output data exchange; and

FIG. 12 is a diagrammatic view of an example of the vehicle control system.

### DETAILED DESCRIPTION OF A PREFERRED EMBODIMENT OF THE PRESENT INVENTION

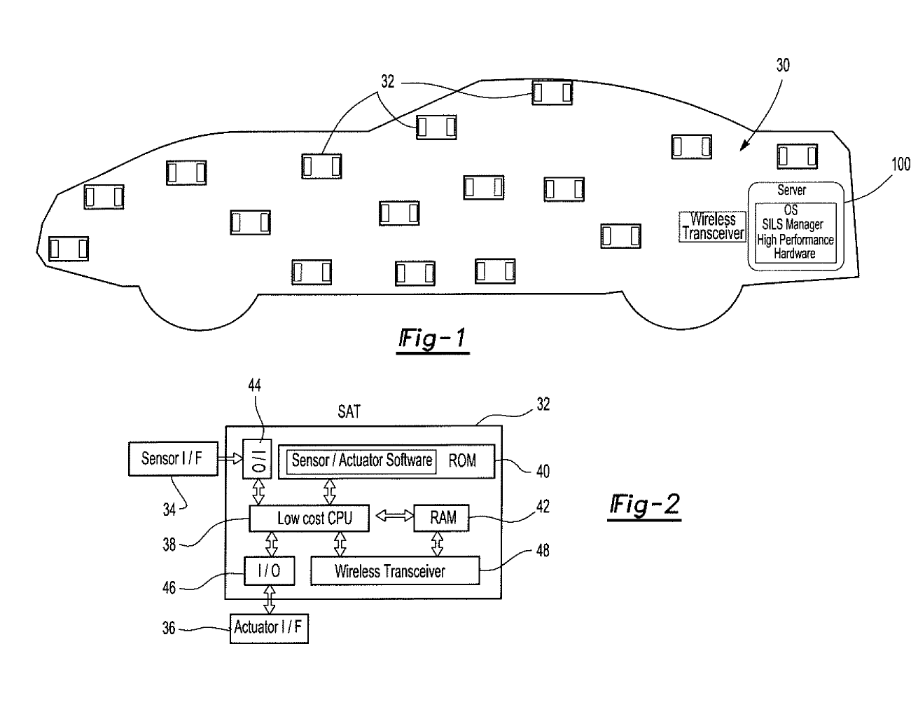

With reference first to FIG. 1, an exemplary vehicle 30 is illustrated with a vehicle control system. Like many modem day automotive vehicles, the automotive vehicle includes a plurality of sensors and actuators throughout the vehicle.

A sensor-actuator-transceiver (SAT) 32 is associated with each ECU throughout the vehicle. Indeed, one SAT may be associated with one or more sensors as well as one or more actuators. Alternatively, a particular SAT may be associated with only a single sensor or a single actuator.

With reference now to FIG. 2, a diagrammatic view of one SAT 32 is shown. The SAT 32 shown in FIG. 2 is associated with one sensor 34 and/or one actuator 36. However, additional sensors 34 as well as additional sensors 36 may also be associated with each SAT 32. Similarly, the SAT 32 is associated with only a single sensor 34 or a single actuator 36 but it may be able to be associated with more than one sensor 34 or one actuator 36.

The SAT 32 includes a low cost CPU 38, such as a PIC, which is programmed by a computer program contained in read only memory 40. The CPU 38 also has access to random access memory (RAM) 42 for temporarily storing variables required by the program contained in the ROM 40.

Still referring to FIG. 2, the SAT 32 also communicates with the sensor 34 through an input/output circuit 44 and similarly communicates with the actuator 36 through an input/output circuit 46. The SAT contains a wireless transceiver 48 which both transmits as well as receives data through a wireless transmission protocol.

Unlike the ECUs in the vehicle control systems, the SAT 32 does not process data that it receives from its sensor 34 or the actuator 36 associated with the SAT 32 to determine optimal or target values used to control the operation of the vehicle. Rather, the sole function of the SAT 32 is to measure specific parameters, e.g. engine oil temperature, engine speed, air pressure, etc., and to create a SAT data packet which is then transmitted by the transceiver 48 or receive a data packet representing the target value of an actuator and then moving its associated actuator to that target value.

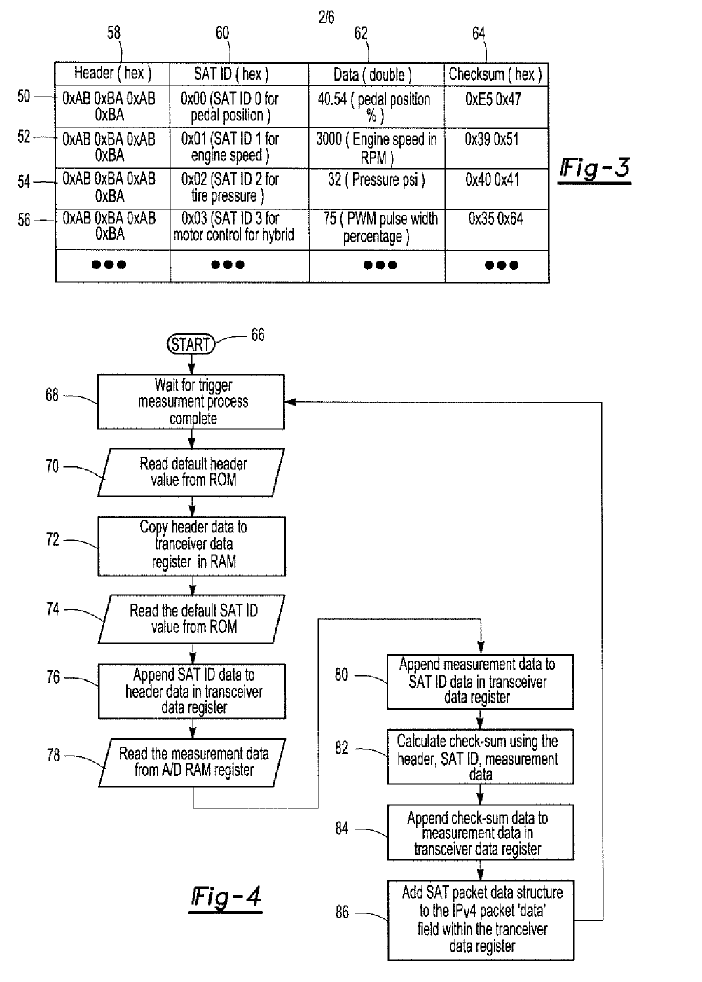

Several exemplary SAT data packets are shown in FIG. 3. For example, one SAT data packet 50 is shown for the SAT 32 associated with the throttle pedal. A further SAT data packet 52 is shown for the SAT 32 associated with the engine speed sensor while a SAT data packet 54 is shown for the SAT associated with the tire pressure. Finally, in this example, a SAT data packet 56 is shown for the motor control for a hybrid vehicle.

Still referring to FIG. 3, each SAT data packet 50-56 includes at least one and preferably several data bytes as a header for each SAT data packet. The header values, shown in FIG. 3 as 0xAB 0xBA 0xAB 0xBA, are the same for each data packet 50-56. In practice, the inclusion of the header bytes 58 is merely an indication that data follows the header bytes 58.

After the header bytes, a SAT ID byte 60 is sent in each data packet 50. The SAT ID byte is unique for each SAT 32 contained in the vehicle so that each SAT 32 can be identified by the SAT ID. The SAT ID 60 not only enables the wireless transceiver 48 in the SAT 32 to receive and process only messages sent to that particular SAT 32, but also allows the transceiver 48 to encode the transmitted messages by the SATs 32 with the SAT ID.

Following the SAT ID byte 60, one or more data bytes 62 represent the actual data either transmitted to or received by the various SATs 32. The actual data, which may be a double byte, will contain data appropriate to the particular SAT.

Lastly, each data packet 50-56 preferably ends with a checksum byte 64. The checksum byte 64 varies depending upon the other bytes in the data packet. The checksum byte 64 will vary from one data packet to another data packet and provides a mechanism for verifying that the data sent or received is valid and uncorrupted.

With reference now to FIG. 4, a flowchart illustrating the construction of a data packet by the SAT is shown. After initiation of the SAT at step 66, step 66 proceeds to step 68. At step 68, the microprocessor 38 (FIG. 2) waits for the appropriate trigger indicating that the measurement process for the sensor 34 has been completed. When completed, step 68 proceeds to step 70.

At step 70, the CPU 38 reads a default header value of the sensor or actuator value from the ROM 40. Step 70 then proceeds to step 72 where the header data (FIG. 3) is copied into a data register contained in the RAM 42. Step 72 then proceeds to step 74.

At step 74, the CPU 38 reads the SAT ID value 60 from the ROM 40 and then proceeds to step 74 where the SAT ID value is appended to the header value contained in the data register in RAM 42. Step 76 then proceeds to step 78.

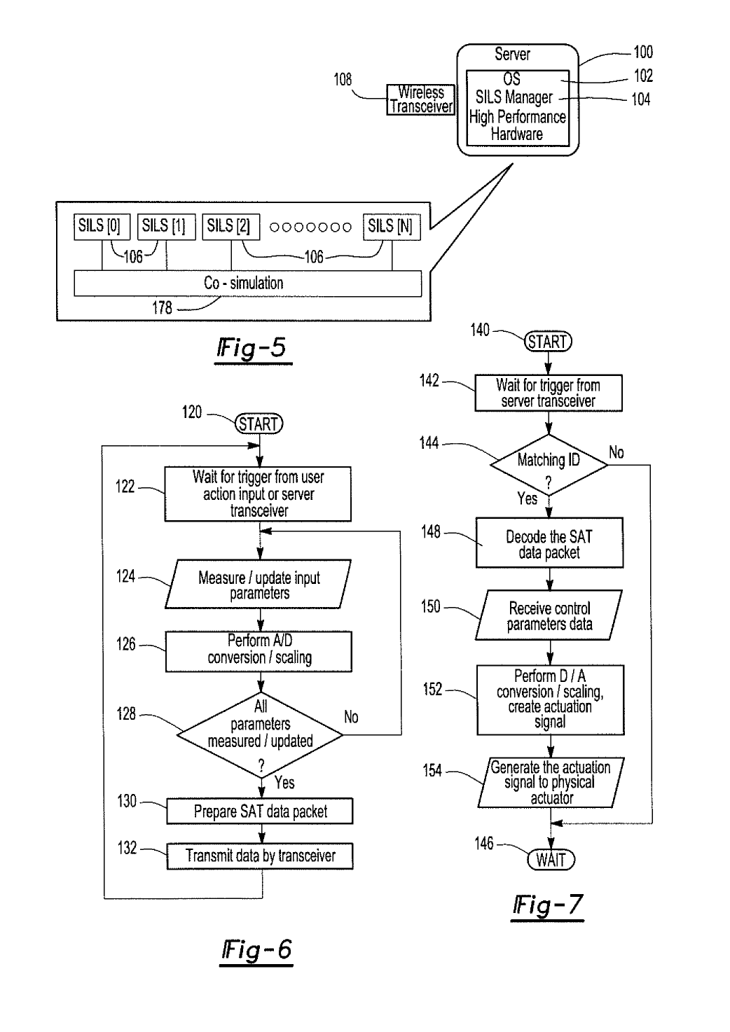

At step 78, the sensor/actuator data is read from an analog/digital memory register contained in the RAM 42. Step 78 then proceeds to step 80 where the data measurement from the sensor/actuator is appended after the SAT ID 60 to the data register contained in RAM 42. Step 80 then proceeds to step 82. At step 82, the checksum is calculated using the header byte 58, SAT ID byte 60, and data bytes 62. Step 82 then proceeds to step 84 where the checksum is appended after the data byte 62 in the data register contained in RAM 42. Preferably, a standard transmission protocol, such as IPv4, is used to transmit messages to and from the transceiver 48. The IP address for all SATs 32 in the vehicle 30 may be identical, e.g. the VIN number for the vehicle 30, although, alternatively, the IP address may be dynamically assigned and may differ for different SATs 32. In this fashion messages received from other sources, such as adjacent vehicles, may be ignored and secure communications between the transceiver 108 (FIG. 5) and the SATs 32 in the same vehicle 30 assured.

Consequently, at step 86 the SAT data packet from step 84, which includes the SAT ID, is appended to the IPv4 packet data field within the data register contained in RAM 42. Since all the data of the SAT is encapsulated in the transmission protocol, the SAT ID is used to identify each SAT which is different from the transmission destination/source address of the IP (Internet Protocol). In any case, following the calculation and appending of the checksum, the data in the data register in RAM 42 is ready for transmission by the transceiver 48. Step 84 then proceeds back to step 68 where the above process is repeated.

With reference to FIGS. 1 and 5, all of the SATs 32 communicate with a server 100 contained in any suitable location on the vehicle 30, such as in the vehicle trunk. The server 100 is a high performance computer server preferably utilizing several cores capable of simultaneously processing data.

The server 100 includes an operating system 102 software layer which controls the overall operation of the server 100. The server executes a software-in-the-loop simulation (SILS) for each SAT 32 through a SILS manager software level 104 in the server 100. Preferably, the SILS for each of the SATs 32 are arranged in different memory partitions 106. The SILS manager 104 then allows the SILS partitions 106 to communicate with each other so that values from one SAT 32 may be provided, as required, to the SILS for other SATs 32 in the system. Preferably, the server 100 utilizes a programmed multi core processor to enable simultaneous calculations for the various SILS 106.

The server 100 then communicates with the various SATs 32 through a wireless transceiver 108 using a standard protocol, such as Bluetooth, IPv4, etc. In this fashion, the server 100 not only is able to receive values from the SATs 32, but also able to transmit values back to the SATs 32 necessary, for example, to change the target position of the various actuators contained in the vehicle 30.

With reference now to FIG. 6, a flowchart for the SAT processor is shown to acquire the value from a sensor associated with the SAT 32. After initiation at step 120, step 120 proceeds to step 122.

At step 122, the SAT processor 38 (FIG. 2) waits for a trigger from a user action or from an interrogation from the server transceiver 108 (FIG. 5). Once the trigger or interrogation is received, step 122 proceeds to step 124.

At step 124, the processor 38 measures or updates the sensor parameters associated with the SAT 32. Step 124 then proceeds to step 126 where the SAT processor performs analog to digital conversion of the analog signal from its associated sensor. The processor 38 also performs scaling if necessary and then proceeds to step 128.

Multiple sensors may be associated with a single SAT 32. Consequently, at step 128, the SAT processor 38 determines if all of the sensor values have been measured or updated. If not, step 128 proceeds back to step 124 where the above-described process is repeated for each sensor associated with the SAT 32. When all of the sensors associated with the SAT 32 have been measured, step 128 proceeds to step 130.

At step 130, the processor prepares the SAT data packet in accordance with the flowchart shown in FIG. 4 and previously described. After the SAT data packet has been formed, step 130 proceeds to step 132 where the SAT data packet is transmitted by the transceiver 48 associated with the SAT 32. Step 132 then proceeds back to step 122 where the above-described process is repeated.

The actual trigger which initiates the data acquisition and subsequent transmission by the SAT will vary depending upon which sensor is associated with the SAT. For example, movement of the accelerator pedal, pressing function keys in the dashboard, braking, etc. all constitute a trigger which ultimately results in the transmission of the SAT data packet preferably encapsulated within an IPv4 message from the SAT and to the transceiver 108 for the server 100.

Upon reception of the SAT data packet from the SAT 32, the SILS software within the server 100 associated with that particular SAT 32 will process the data and generate a control signal that is transmitted back to the SAT 32 or to other SATs 32, as a SAT packet, preferably encapsulated within an IPv4 message. Upon reception of the SAT data packet by the SAT transceiver 48, the SAT processor 38 processes the received data and generates the appropriate signals through the input/output circuit 46 to the actuator 36 to move the actuator 36 to a target value.

With reference now to FIG. 7, a flowchart illustrating the processing of a received signal from the server by a SAT 32 is shown. After initiation of the software for the SAT processor 38 at step 140, step 140 proceeds to step 142. At step 142, the software for the SAT processor 38 waits to receive a signal or data packet transmission from the server 100. Upon receipt of a data packet transmission from the server 100, step 142 proceeds to step 144.

At step 144, the SAT processor 38 examines the received data packet and compares the SAT received ID byte 60 (FIG. 3) to determine if the received SAT ID byte matches the SAT ID assigned to the SAT 32. If not, step 144 proceeds to step 146 and waits for the next transmission from the server transceiver 108. Conversely, if the received SAT ID byte 60 matches the SAT ID byte assigned to the SAT 32, step 144 instead proceeds to step 148.

At step 148, the SAT processor 38 decodes the received SAT data packet. Such decoding of the SAT data packet at step 148 not only includes the extraction of the data bytes 62, but also a calculation and comparison with the checksum byte 64 to ensure that the received data has not been corrupted. Step 148 then proceeds to step 150 where the data bytes 62 are extracted from the data packet. Step 150 proceeds to step 152 where digital to analog conversion and scaling, if required, is performed by the SAT processor 38. After D/A conversion and scaling, the appropriate actuation signal for the actuator 36 is created. Step 152 then proceeds to step 154 where the SAT processor 38 generates the appropriate output signal 36 through the input/output circuit 46 to move the actuator 36 to a target value. Step 154 then proceeds to step 146 to await the next signal generation from the server transceiver 108.

Unlike the vehicle control systems which utilize multiple ECUs to process sensor outputs, calculate target values for actuators, and then control the actuation of those actuators, the SATs which replace the ECUs merely perform lower layer hardware driver software which performs only two basic functions. First, the lower layer SAT software receives the measured value from the sensor as data, packages that data into a SAT data packet, and then transmits that data packet to the server 100. Secondly, the SAT processor receives the SAT data packet for an actuator from the server, decodes the data packet which contains a target value for the actuator, and then outputs the appropriate data signal, i.e. a variable voltage, PWM, or other signal, to the actuator in order to control the position of the actuator. However, unlike the vehicle control systems using the ECUs, the SATs 32 do not process data in order to determine a target value for the actuator. Likewise, the SATs 32 do not directly communicate with each other through a network such as a CAN network. Rather, each SAT merely communicates with the server 100, preferably by wireless transmission.

Conversely, the server 100 performs all of the data processing on data received from the SATS to determine the target values for the vehicle actuators. This higher layer of application software is performed in a SILS environment with each SAT assigned a different data partition to process the input and output data for that particular SAT. The actual programming of the SILS is performed in a higher level language, such as C++.

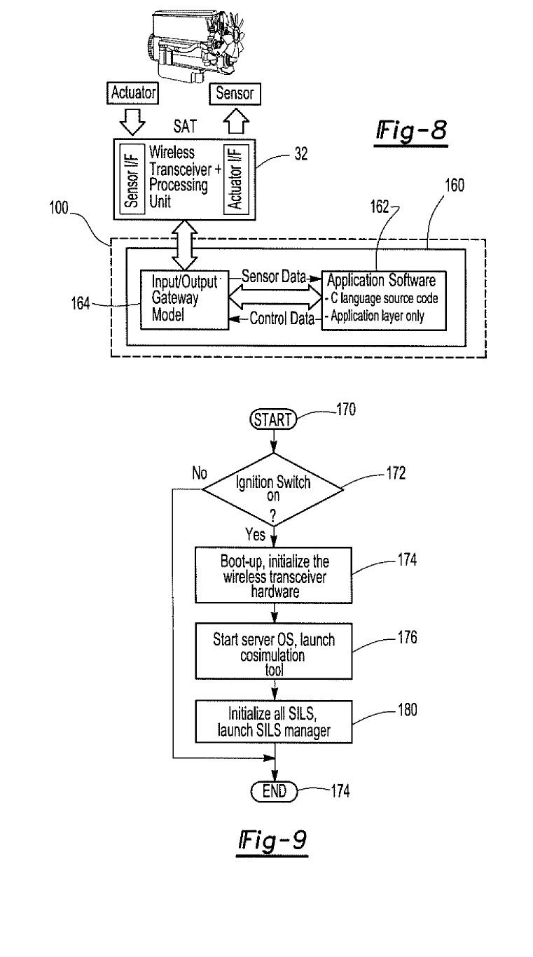

With reference then to FIG. 8, a block diagram of the interface between one SILS 106 and its associated SAT 32 is shown. One SILS 106 is associated with each different SAT 32 in the vehicle.

The SILS 160 includes application software 162 which is written in a high level language such as C or C++. The application software 162 is preferably contained within its own memory partition allotted by the server 100 and will vary in size depending upon the complexity of the required processing of the input and output data for the SAT 32. This application software 162, furthermore, operates only in the application layer under control of the operating system for the server 100. The application software 162 does not include lower level software processing, such as device drivers. The application software 162 processes both input data or sensor data received from the SAT 32 and generates the control data to be transmitted by the transceiver 108 for the server 100 to the SAT 32.

The application software 162 communicates with its associated SAT 32 through an input/output gateway 164. The input/output gateway model 164 then communicates with its associated SAT 32 through the wireless transceiver 108 in the server 100.

With reference now to FIGS. 5 and 9, the SILS manager 104 operates under control of the operating system 102 for the server 100 to control the communications between the SILS [0]-SILS [N] where N equals the number of SATs 32 contained in the vehicle. In order to initiate the SILS manager 102, after initiation of the server at step 170, step 170 proceeds to step 172 which determines if the ignition switch is on. If not, step 172 exits at step 174.

Conversely, if the ignition switch is on, step 172 instead proceeds to step 174 which initializes the hardware for the wireless transceiver 108. Step 174 then proceeds to step 176 which initiates or boots the operating system 102 for the server 100 and also launches the co-simulation tool 178 (FIG. 5). This co-simulation tool 178 enables the SILS [0]-SILS [N] to communicate with each other. Step 176 then proceeds to step 180. At step 180, the SILS manager 104 is launched and all of the SILS [0]-SILS [N] are initiated. Following initiation of the SILS manager and SILS at step 180, the server is fully initialized.

With reference now to FIG. 10, a flowchart illustrating the operation of the SILS manager is shown after initiation of the SILS manager at step 180 (FIG. 9). After initiation of the SILS manager at step 182, step 182 proceeds to step 184 where it is determined if the ignition switch is on. If not, step 184 branches to step 186 and exits. Otherwise, step 184 proceeds to step 188.

At step 188, the SILS manager 104 waits for a trigger user action from SAT(n) where n=0−N and N=number of SATs 32. Upon receipt of a trigger action, step 188 proceeds to step 190 which decodes the data packet to determine the SAT ID byte 60 and thus identify the SAT(n) which transmitted the SAT data packet. Step 190 then proceeds to step 192.

At step 192 the SILS manager decodes the remainder of the data packet 50-56 (FIG. 3) and launches the SILS software 106 associated with the SILS ID byte identified at step 190. Step 192 also transfers the data byte 62 and other data payload to the launched SILS 106 associated with the SAT. Step 192 then proceeds to step 194.

At step 194, the SILS manager 102 waits for a trigger from the SILS 106 indicative that the SILS 106 has completed processing of the received data packet from SAT(n). Step 194 then proceeds to step 196 where the SILS manager 104 executes SILS software which processes the output or data payload received at step 194. Step 196 then proceeds to step 198 where the processed data is packaged into a data packet 50-56 (FIG. 3). Step 198 then proceeds to step 200 where the wireless transceiver 108 for the server 100 is activated to transmit the appropriate actuator data to one or more SATs 32. The transmission of data at step 200 may be a transmission back to SAT(n) which was identified at step 190, or a different SAT 32, such as SAT(m), within the system.

After transmission of the SAT data packet to the appropriate SAT, step 200 branches back to step 188 where the above process is continuously iterated.

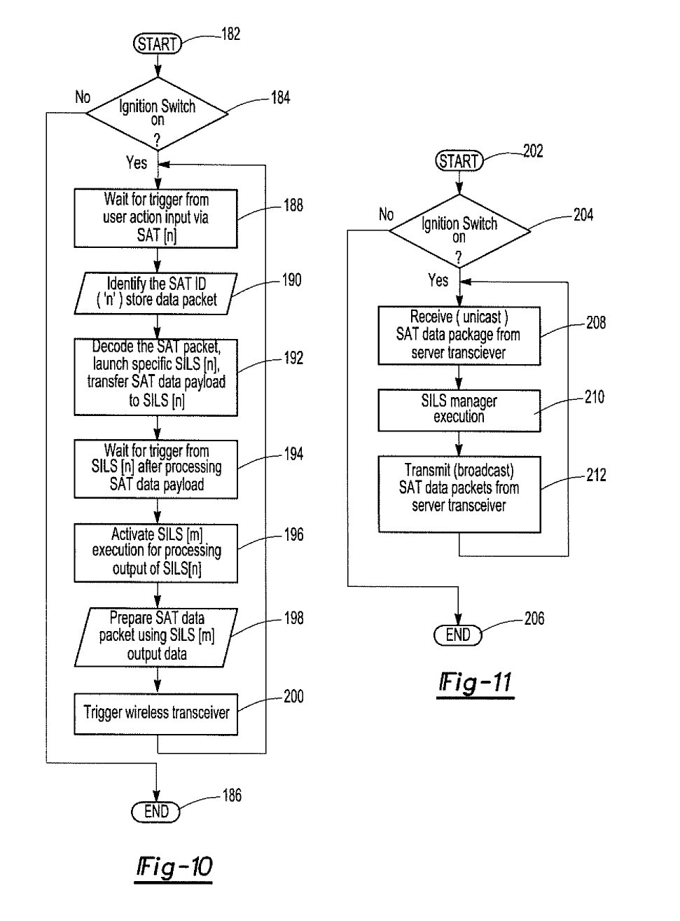

With reference now to FIG. 11, a simplified flowchart illustrating the overall flow of the server input/output data exchange is illustrated. After initiation at step 202, step 202 proceeds to step 204 where it is determined if the ignition switch is on. If not, the program exits at step 206. Otherwise, step 204 proceeds to step 208.

At step 208, the SAT data packet is received by the server transceiver 108. Step 208 then proceeds to step 210 where the SILS manager 104 initializes and executes the appropriate SILS 106 depending upon the identification or SAT ID byte 60 (FIG. 3) contained in the SAT data packet and which has been described more fully with respect to FIG. 10. Step 210 then proceeds to step 212.

At step 212, the wireless transceiver 108, under control of the SILS manager 104, transmits one or more SAT data packets, each encoded with the SAT ID which identifies the SAT 32 to which the message is intended, wirelessly to the SATs 32. Step 212 then branches back to step 108 where the above process is repeated.

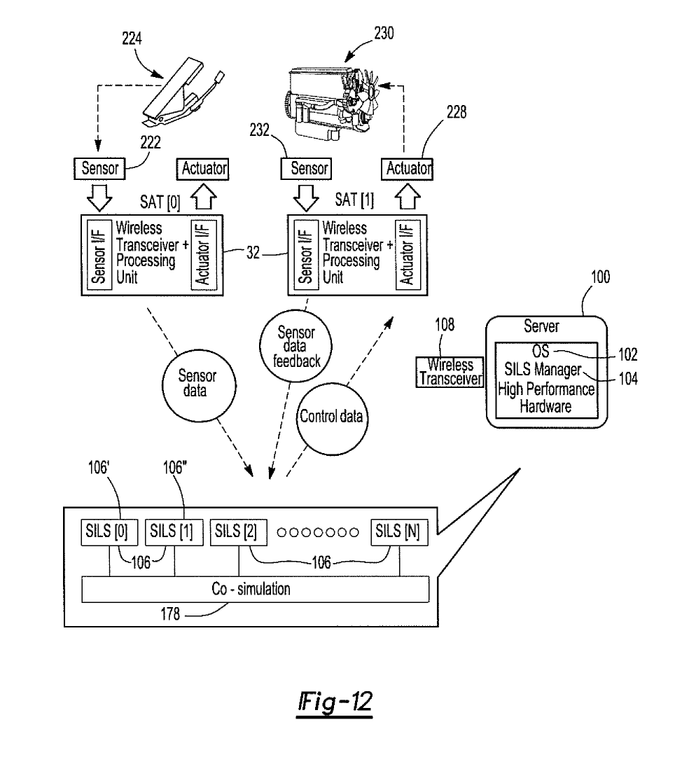

With reference now to FIG. 12, a simplified example of the communication between the SATs 32, namely SAT [0] and SAT [1], and the server 100 is shown. For the purpose of this example, SAT [0] represents the SAT associated with a sensor 222 which senses the position of an accelerator pedal 224 for the vehicle. The second SAT [1] is associated with the engine throttle 230. This SAT 32 includes both an actuator 228 capable of moving the engine throttle 230 as well as a sensor 232 which senses the position of the throttle 230. In addition, for this example it is assumed that the server operating system 102 and SILS manager 104, as well as all SATs 32, have been initiated, are operational, and the ignition switch is turned on.

Assuming that the accelerator pedal 224 is depressed, SAT [0] will detect the movement of the accelerator pedal 224 as a trigger and initiate the sensor processing software shown in FIG. 6 to create the data packet for the SAT [0]. Such an exemplary data packet is illustrated as data packet 50 in FIG. 3.

In constructing the data packet 50, the processor contained in the SAT [0] has merely performed lower level processing of the signal from the sensor 222 for analog/digital conversation and scaling. No further processing of the sensor data 22 is performed by the SAT [0].

After the data packet is completed for the SAT [0], the SAT [0] transmits by wireless transmission the SAT [0] data packet 50 to the server 100 which receives the SAT [0] data packet via a wireless transceiver 108. Upon receipt of the SAT [0] data packet by the server 100, the SILS manager 104 executes the program illustrated in FIG. 10, which identifies the SAT 32 transmitting the data packet, i.e. SAT [0], and then executes the SILS [0] program contained in the software partition associated with the SAT [0]. During processing of the data by the SILS [0], the SILS [0] determines that adjustment of the engine throttle 230 is necessary. However, a different SAT [1] is associated with the engine throttle 230.

Consequently, the SILS [0] communicates with the SILS [1] software in its data partition which is associated with the SAT [1] via the co-simulation tool 178. After processing by the SILS [1], the SILS manager 104 creates a data packet containing actuator data for moving the engine throttle 230. This data packet is transmitted with the SAT ID set for SAT [1] which decodes the data packet from the server 100 and actuates the actuator 228 to move the engine throttle 230 to a target position.

In addition, SAT [1] also contains a position sensor 232 for the throttle 230. The processor for SAT [1] then creates a data packet containing data representative of the position of the throttle position 230 and, after analog/digital conversion and scaling, optionally transmits this data back to the server 100 as a feedback where the data is manipulated and/or stored as required by the SILS manager 104.

During the operation of the vehicle, communication between not only SAT [0] and SAT [1] and the server 100, but also communication between the server 100 and all of the other SATs 32 contained within the vehicle, occurs continuously. Although only one wireless communication between the server transceiver 108 and the various SATs 32 occurs at any given instant, the transmission of data from and to the server transceiver 108 occurs so rapidly, i.e. a matter of microseconds, that no degradation in vehicle performance results even in the event that multiple SATs are attempting to transmit their messages at substantially the same time.

Although in the preferred embodiment of the invention, the communication between the server 100 and the SATs 32 is by wireless communication, alternatively, the SATs 32 may be hardwired to the server 100.

From the foregoing, it can be seen that the present invention provides a unique vehicle control system in which SATs are distributed throughout the vehicle which replace the electronic control units (ECUs) used to control the operation of actuators and sensors throughout the vehicle. Since the processing performed by each SAT constitutes only lower level processing, i.e. driver software, AID conversion, and scaling, a very inexpensive processor may be used for each SAT which significantly lowers the overall price of the SATs as compared to the previously used ECUs. Furthermore, since each SAT only performs lower level processing, the overall construction of the SATs may be substantially standardized throughout the vehicle.

Conversely, the higher level processing of the sensor input as well as the calculation and generation of control signals to control the actuators throughout the vehicle is performed solely by the server 100 under control of the SILS manager 104. The SILS manager 104 is programmed using a higher level language, such as C or C++, programming for the sensors and actuators is greatly simplified as well as simulation of the overall system. Furthermore, since the SILS manager 104 assigns different data partitions 106 for each SILS, each SILS is associated with its own unique SAT, the execution of the SILS by the SILS manager 104 occurs essentially in real time.

The hardware required by the server 100 is preferably higher level hardware and thus relatively costly. However, the replacement of all of the ECUs in the engine control system by the inexpensive SATs more than adequately offsets the increased cost of the server 100 and its associated hardware.

From the foregoing, it can be seen that the present invention provides a unique vehicle control system which is especially suited for automotive vehicles. Having described our invention, however, many modifications thereto will become apparent to those skilled in the art to which it pertains without deviation from the spirit of the invention as defined by the scope of the appended claims.

We claim:

1. A vehicle control system for a vehicle having a plurality of sensors and a plurality of actuators, said control system comprising:
a sensor-actuator-transceiver (SAT) associated with each sensor and/or actuator, each SAT being configured to read and transmit the value of its associated sensor and/or change the position of its associated actuator in response to an interrogation signal,
a server configured to execute simulation software for each SAT which determines the target position of the actuators as a function of the value of at least one sensor, and
a main transceiver configured to transmit signals to said SATs to actuate said actuators to move to said target position and receives sensor output data from said SATs.

2. The vehicle control system as defined in claim 1 wherein said SATs transmit said value to said server by wireless transmission.

3. The vehicle control system as defined in claim 1 wherein said main transceiver transmits to said SATs by wireless transmission.

4. The vehicle control system as defined in claim 1 wherein a unique SAT ID is assigned to each SAT and wherein said main transceiver communicates with said SATs by Internet Protocol (IP) packet having a target IP address and a SAT data packet containing the SAT ID, the SAT ID being used to identify the SAT to which the transmission is directed.

5. The vehicle control system as defined in claim 1 wherein said server executes a software-in-the-loop-simulation (SILS) for each SAT.

6. The vehicle control system as defined in claim 5 wherein the SILS for each SAT is assigned a separate memory partition for the server.

7. The vehicle control system as defined in claim 5 wherein each SILS comprises application software for its associated SAT and an input/output gateway to prepare the data for output to its associated SAT or input of data from its associated SAT for use by the application software.

8. The vehicle control system as defined in claim 5 wherein said server executes co-simulation of said simulation software for a plurality of SATs and wherein data for each said SILS is accessible by other SILS.

9. The vehicle control system as defined in claim 8 wherein each co-simulation executes in a separate memory partition accessible to said server.

10. The vehicle control system as defined in claim 1 wherein said server executes a SILS manager program which controls communication between said simulation software for said SATs.

11. The vehicle control system as defined in claim 1 wherein at least one of said SATs generates a data packet containing a SAT identifier and sensor data for transmission to said server.

12. The vehicle control system as defined in claim 11 wherein said data packet comprises a check sum.

13. The vehicle control system as defined in claim 11 wherein said at least one of said SATs initiates generation of said data packet in response to a trigger signal.

14. The vehicle control system as defined in claim 13 wherein said trigger signal is received from said server.

15. The vehicle control system as defined in claim 13 wherein said trigger signal is generated in response to an action of an operator of the vehicle.

16. The vehicle control system as defined in claim 1 wherein each SAT includes a processor which only performs driver input/output, analog/digital conversion and scaling for its associated sensor and/or actuator.
